(19) United States
(12) Patent Application Publication
(10) Pub. No.: US 2024/0079586 A1
(43) Pub. Date: Mar. 7, 2024

(54) FLUORIDE ION SECONDARY BATTERY NEGATIVE ELECTRODE MIXTURE COMPOSITE, FLUORIDE ION SECONDARY BATTERY NEGATIVE ELECTRODE AND SECONDARY BATTERY USING FLUORIDE ION SECONDARY BATTERY NEGATIVE ELECTRODE MIXTURE COMPOSITE, AND PRODUCTION METHOD FOR FLUORIDE ION SECONDARY BATTERY NEGATIVE ELECTRODE MIXTURE COMPOSITE

(71) Applicant: HONDA MOTOR CO., LTD., Tokyo (JP)

(72) Inventors: Akihisa TANAKA, Saitama (JP); Yoshiyuki MORITA, Saitama (JP)

(21) Appl. No.: 17/767,442

(22) PCT Filed: Oct. 9, 2019
(86) PCT No.: PCT/JP2019/039885

§ 371 Date: Apr. 8, 2022

(51) Int. Cl. H01M 4/58; H01M 4/136; H01M 10/05

(52) U.S. Cl. CPC H01M 4/582; H01M 4/136; H01M 10/05; H01M 2004/027

(57) ABSTRACT

Provided are: a fluoride ion secondary battery negative electrode mixture composite that makes it possible to achieve a fluoride ion secondary battery that has high initial charging/discharging efficiency and is ready to be charged; a fluoride ion secondary battery negative electrode and a secondary battery that use the composite; and a production method for the composite.

The present invention uses nanoparticle-sized aluminum and a metal fluoride as negative electrode active materials to form a composite with other negative electrode mixture components and thereby suppresses the formation of an aluminum fluoride coating that is formed by a re-fluoridation reaction after de-fluoridation and also suppresses the aggregation of particles of the negative electrode active materials.

### TECHNICAL FIELD

The present invention relates to a negative electrode material mixture composite for a fluoride ion secondary battery, a negative electrode for a fluoride ion secondary battery and a secondary battery each using the composite and a method for manufacturing the composite.

### BACKGROUND ART

Conventionally, as secondary batteries having a high energy density, lithium ion secondary batteries are widely used. The lithium ion secondary battery has a structure in which a separator is present between a positive electrode and a negative electrode and a liquid electrolyte (electrolytic liquid) is filled.

Since the electrolytic liquid of the lithium ion secondary battery is generally a flammable organic solvent, in particular, there might be a problem in safety for heat. Hence, instead of an organic liquid electrolyte, a solid-state battery using an inorganic solid electrolyte is proposed (see Patent Document 1).

As the battery using the solid electrolyte as described above, a secondary battery using fluoride ions is also considered (see Patent Document 2). A fluoride ion secondary battery is a secondary battery which uses a fluoride ion (F⁻) as a carrier, and it is known that the fluoride ion secondary battery has high theoretical energy. It is expected that the battery characteristics thereof exceed those of the lithium ion secondary battery.

Here, as a negative electrode active material for the fluoride ion secondary battery, for example, MgF₂, CaF₂, CeF₃ and the like are reported (see Non-Patent Documents 1 and 2). However, in the fluoride ion secondary batteries using these negative electrode active materials, the charge/discharge efficiency thereof is 10 to 20%, and thus the energy efficiency thereof serving as a secondary battery was disadvantageously low. The charge/discharge capacity thereof is only about 10 to 20% of a theoretical capacity, and thus a high capacity was not achieved as compared with the lithium ion secondary battery and an Ni-MH battery which are currently used.

As the solid electrolyte used in the fluoride ion secondary battery, for example, La₁₋ₓBaₓF₃₋ₓ where x=0.01 to 0.2 (hereinafter referred to as an LBF) is mentioned (see Non-Patent Documents 1 to 4). As shown in FIG. 1, the reduction side potential window of the LBF receives a constraint at −2.41 V vs. Pb/PbF₂ which is the potential of La/LaF₃ calculated from Gibbs energy.

By contrast, as the potentials of the negative electrode active materials for the fluoride ion secondary battery which are currently reported, as shown in FIG. 1, MgF₂ has a potential of −2.35 to −2.87 V vs. Pb/PbF₂, CaF₂ has a potential of −2.85 to −2.89 V vs. Pb/PbF₂ and CaF₃ has a potential of −2.18 to −2.37 V vs. Pb/PbF₂. Hence, under the constraint of −2.41 V serving as the reduction potential window of the LBF, the defluorination/refluorination reactions of the negative electrode active materials described above could not be provided with consideration given to the overvoltage thereof.

On the other hand, with respect to the positive electrode reaction, for example, for positive electrode active materials such as Cu/CuF₂ and Bi/BiF₃, the results of charge/discharge tests indicating high utilization rates and reversible reactions are reported (see Patent Documents 3 and 4 and Non-Patent Documents 1 to 3).

Hence, in order to achieve, in the fluoride ion secondary battery, a practical all-battery reaction in which positive/negative electrode reactions are combined, it was necessary to provide a negative electrode active material which causes a reversible negative electrode reaction at a high utilization rate.

For this requirement, Patent Document 5 focuses attention on aluminum fluoride (AlF₃: −1.78 V vs. Pb/PbF₂) in which charge/discharge reactions (defluorination/refluorination reactions) are present in the constraint of −2.41 V serving as the potential window of the LBF that is the fluoride ion solid electrolyte, and further proposes a negative electrode active material obtained by modifying the aluminum fluoride (AlF₃) such that fluoride ions (F⁻) are previously and partially desorbed from the structure of the perfect crystal of six-coordinated octahedron included in the aluminum fluoride (AlF₃) and that holes are provided in positions where fluorine atoms were present.

In the negative electrode active material of Patent Document 5, the holes which are provided in the positions where fluorine atoms were present serve as the starting point of the defluorination/refluorination reactions, and thus it is possible to cause a desired negative electrode reaction at a high utilization rate in a reversible manner.
Patent Document 1: Japanese Unexamined Patent Application, Publication No. 2000-106154
Patent Document 2: Japanese Unexamined Patent Application, Publication No. 2017-050113
Patent Document 3: Japanese Unexamined Patent Application, Publication No. 2018-206755
Patent Document 4: Japanese Unexamined Patent Application, Publication No. 2019-087403
Patent Document 5: Japanese Patent Application No. 2018-059703
Non-Patent Document 1: J. Mater. Chem. A. 2014.2.20861-20872
Non-Patent Document 2: J. Solid State Electrochem (2017)21:1243-1251
Non-Patent Document 3: J. Mater. Chem., 2011, 21, 17059
Non-Patent Document 4: Dalton Trans., 2014, 43, 15771-15778

### DISCLOSURE OF THE INVENTION

### Problems to be Solved by the Invention

However, in the fluoride ion secondary battery using the negative electrode active material proposed in Patent Document 5, the electrification efficiency of an electrochemical first cycle is about 50%, and thus the electrification efficiency was required to be further enhanced.

Since in the fluoride ion secondary battery using the negative electrode active material proposed in Patent Document 5, a compound which includes fluoride ions is selected as a positive electrode serving as the opposite electrode, the fluoride ion secondary battery is a battery which starts from discharge. However, in terms of stability of an active material within an electrode, the manufacturing of a secondary battery is preferably performed in a discharged state where an energy state is low. In other words, the secondary battery is preferably a battery which starts from charge.

The present invention is made in view of the background technologies described above, and an object thereof is to provide, in a fluoride ion secondary battery, a negative electrode material mixture composite for a fluoride ion secondary battery which can realize the fluoride ion secondary battery having high initial charge/discharge efficiency and starting from charge, a negative electrode for a fluoride ion secondary battery and a secondary battery each using the composite and a method for manufacturing the composite.

### Means for Solving the Problems

The present inventors have conducted thorough studies on the cause of the reduction in the electrification efficiency of the negative electrode active material proposed in Patent Document 5. Then, the present inventors have considered that the aluminum fluoride formed by the refluorination reaction after the defluorination coats the surface of the negative electrode active material to form an insulating layer, and that thus the reactivity is lowered.

In addition, the present inventors have considered that since the negative electrode active material is nanoparticles, the particles are agglomerated at the time of initial charge/discharge, and that consequently, an electron conduction path and an ion conduction path are not sufficiently formed.

The present inventors further have considered that, when a compound capable of discharging fluoride ions serving as an ion carrier at the time of charge can be caused to be present as the negative electrode active material, it is possible to form a battery using, as a positive electrode, a compound which does not include fluoride ions.

Then, the present inventors have found that when nanoparticle-sized aluminum and a metal fluoride are used as the negative electrode active material to form a composite together with the other components of a negative electrode material mixture, it is possible to suppress the coating with the aluminum fluoride formed by the refluorination reaction after the defluorination and to suppress the agglomeration of the particles of the negative electrode active material, and that consequently, a fluoride ion secondary battery having high initial charge/discharge efficiency and capable of starting from charge can be realized, with the result that the present invention is completed.

Specifically, a negative electrode material mixture composite for a fluoride ion secondary battery according to the present invention includes: a negative electrode active material; and a fluoride ion conductive fluoride, and the negative electrode active material includes aluminum and a metal fluoride.

The metal fluoride may discharge fluoride ions under a battery reaction condition and may include a metal with an SHE potential equal to or greater than 0 V.

The metal fluoride may be silver fluoride.

The aluminum may be in the form of particle with an average particle diameter of 10 to 200 nm.

The negative electrode material mixture composite for a fluoride ion secondary battery may further include carbon black.

A negative electrode for a fluoride ion secondary battery according to another invention includes the negative electrode material mixture composite for a fluoride ion secondary battery.

A fluoride ion secondary battery according to another invention includes: the negative electrode; a solid electrolyte; and a positive electrode.

A method for manufacturing a negative electrode material mixture composite for a fluoride ion secondary battery according to another invention includes: a mixture step of mixing a negative electrode active material, a fluoride ion conductive fluoride and carbon black to obtain a negative electrode material mixture; a complexing step of subjecting the negative electrode material mixture to grinding and mixing treatment to complex the negative electrode active material, the fluoride ion conductive fluoride and the carbon black so as to obtain a composite, and the negative electrode active material includes aluminum and a metal fluoride.

In the method for manufacturing a negative electrode material mixture composite for a fluoride ion secondary battery, the metal fluoride may discharge fluoride ions under a battery reaction condition and may include a metal with an SHE potential equal to or greater than 0 V.

In the method for manufacturing a negative electrode material mixture composite for a fluoride ion secondary battery, the metal fluoride may be silver fluoride.

In the method for manufacturing a negative electrode material mixture composite for a fluoride ion secondary battery, the aluminum may be in the form of particle with an average particle diameter of 10 to 200 nm.

In the method for manufacturing a negative electrode material mixture composite for a fluoride ion secondary battery, the grinding and mixing treatment may be dry grinding.

In the method for manufacturing a negative electrode material mixture composite for a fluoride ion secondary battery, the grinding and mixing treatment may be performed with a ball mill.

### Effects of the Invention

With a negative electrode material mixture composite for a fluoride ion secondary battery according to the present invention, it is possible to realize a fluoride ion secondary battery which has high initial charge/discharge efficiency and which starts from charge.

### BRIEF DESCRIPTION OF THE DRAWINGS

FIG. 1 is a diagram showing potentials calculated from Gibbs energy;

FIG. 2 is an XRD chart of various types of materials and a negative electrode material mixture composite for a fluoride ion secondary battery in Example 1;

FIG. 3 is a diagram showing a method for producing fluoride ion secondary batteries in Example and Comparative Examples;

FIG. 4 is a cross-sectional view of the fluoride ion secondary batteries produced in Example and Comparative Examples; and

FIG. 5 is charge/discharge curves of the fluoride ion secondary batteries produced in Example and Comparative Examples.

### PREFERRED MODE FOR CARRYING OUT THE INVENTION

An embodiment of the present invention will be described below.

### <Negative Electrode Material Mixture Composite for Fluoride Ion Secondary Battery>

The negative electrode of a fluoride ion secondary battery needs to be able to store fluoride ions (F⁻) at the time of discharge and to discharge fluoride ions (F⁻) at the time of charge.

A negative electrode material mixture composite for a fluoride ion secondary battery according to the present invention includes a negative electrode active material and a fluoride ion conductive fluoride, and is a composite which includes aluminum and a metal fluoride as the negative electrode active material.

The negative electrode material mixture composite for a fluoride ion secondary battery according to the present invention preferably includes, as constituent components, aluminum and the metal fluoride serving as the negative electrode active material and the fluoride ion conductive fluoride, and may be a composite which arbitrarily includes other components.

In the negative electrode material mixture composite for a fluoride ion secondary battery according to the present invention, aluminum serving as the negative electrode active material forms an alloy with another constituent component of the composite, and aluminum is not present as a simple substance.

[Shape of Composite]

The shape of the negative electrode material mixture composite for a fluoride ion secondary battery according to the present invention is not particularly limited. Among various shapes, the negative electrode material mixture composite is preferably granulated into spherical particles. Within each of the particles, aluminum and the metal fluoride serving as the negative electrode active material, the fluoride ion conductive fluoride and other arbitrary components are preferably present.

In a case where the negative electrode material mixture composite is granulated into spherical particles, when the electrode is pressed, the electrode into which the negative electrode material mixture composite is further filled without any gap can be produced, with the result that the volumetric energy density of the battery can be enhanced.

When the negative electrode material mixture composite is spherical, the constituent components of the composite are present within each of the composite particles, and thus an electron conduction path and an ion conduction path for fluorination/defluorination reactions necessary for an electrochemical reaction can be formed into nanosized paths.

In order to enhance the efficiency of the electrochemical reaction in the fluoride ion secondary battery, it is effective to enlarge the surface area of the materials of the negative electrode, and when the negative electrode material mixture composite is spherical, a negative electrode for a fluoride ion secondary battery which is the aggregate of spheres has a high surface area. Consequently, a contact area with a solid electrolyte included in an adjacent solid electrolyte layer can be increased.

(Average Particle Diameter)

When the negative electrode material mixture composite for a fluoride ion secondary battery according to the present invention is spherical, the average particle diameter thereof is preferably in a range of 0.5 to 10 μm. The average particle diameter is particularly preferably in a range of 1 to 5 μm.

The average particle diameter of the negative electrode material mixture composite for a fluoride ion secondary battery is in the range described above, and thus when grinding and mixing treatment for obtaining the composite particles is performed, the particles are made to collide with each other so as to be granulated, with the result that within the microsized particles, the electron conduction path and the ion conduction path for fluorination/defluorination reactions are securely adhered and formed. Since the structure of the particles having the electron conduction path and the ion conduction path can follow a change in volume caused by the reaction of aluminum serving as the negative electrode active material, the collapse of the structure of a negative electrode layer can be suppressed, with the result that the reversibility of the electrochemical reaction can be more improved.

[Negative Electrode Active Material]

The negative electrode active material of the negative electrode material mixture composite for a fluoride ion secondary battery according to the present invention includes aluminum and the metal fluoride.

[Aluminum]

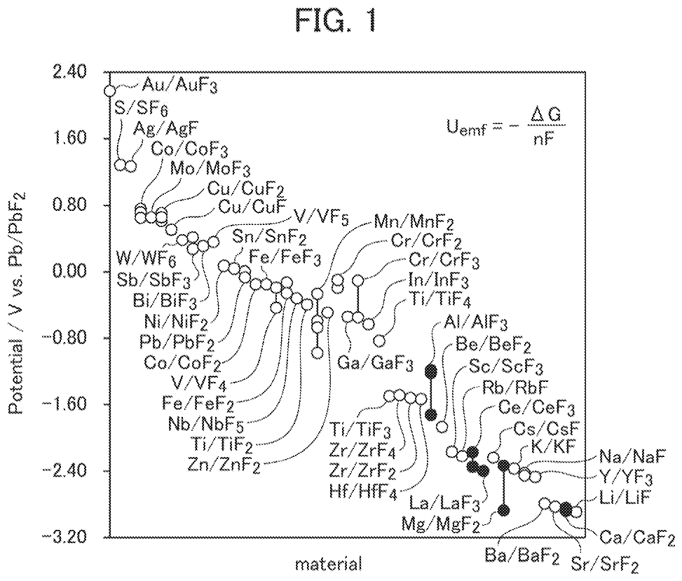

As shown in FIG. 1, the potential of aluminum fluoride AlF₃ which is a fluoride of aluminum is −1.78 V vs. Pb/PbF₂, and charge/discharge reactions (defluorination/refluorination reactions) are present in the constraint of −2.41 V serving as the potential window of an LBF which is a fluoride ion solid electrolyte.

Hence, the defluorination/refluorination reactions of aluminum sufficiently proceed under the constraint of −2.41 V serving as the reduction potential window of the LBF with consideration given to the overvoltage thereof. Since aluminum is an inexpensive material, it is economically advantageous to use aluminum.

On the surface of aluminum, an oxide film may be present.

(Shape)

The shape of aluminum serving as the negative electrode active material is preferably spherical. The negative electrode active material is spherical, and thus when the electrode is pressed, the electrode into which the negative electrode active material is further filled without any gap can be produced, with the result that the volumetric energy density of the battery can be enhanced.

(Average Particle Diameter)

The average particle diameter of aluminum is preferably in a range of 10 to 200 nm, and is particularly preferably in a range of 40 to 100 nm.

The average particle diameter of aluminum serving as the negative electrode active material is in the range of 10 to 200 nm, and thus the negative electrode material mixture composite for a fluoride ion secondary battery which is obtained is a substantially true spherical granulated composite.

[Metal Fluoride]

Preferably, the metal fluoride serving as the second component of the negative electrode active material discharges fluoride ions under a battery reaction condition and includes a metal with an SHE potential equal to or greater than 0 V.

In a case where the metal fluoride including the metal with an SHE potential equal to or greater than 0 V is used as the negative electrode active material, when the negative electrode is subjected to a reduction reaction, the metal fluoride is reduced to the metal, and fluoride ions can be discharged.

The SHE (standard hydrogen electrode) potentials of various metals are shown below.

Ag²⁺+e⁻→Ag⁺ (1.98 V_{SHE})

Bi³⁺+3e⁻→Bi (0.32 V_{SHE})

Cu²⁺+2e⁻→Cu (0.34 V_{SHE})

Mn³⁺+e⁻→Mn²⁺ (1.5 V_{SHE})

Pb²⁺+2e⁻→Pb (−0.13 V_{SHE})

Sn²⁺+2e⁻→Sn (−0.14 V_{SHE})

Sn⁴⁺+2e⁻→Sn²⁺ (0.15 V_{SHE})

Examples of the metal fluoride which is preferable in the present invention and includes the metal with an SHE potential equal to or greater than 0 V include BiF₃, CuF₂, MnF₃, SnF₄, AgF₂ and the like.

Furthermore, the metal fluoride serving as the second component of the negative electrode active material preferably has electron conductivity and fluoride ion conductivity after fluoride ions are discharged by the reduction reaction. When the metal fluoride is insulating or the fluoride ion conductivity is low after fluoride ions are discharged, the reactivity of the battery is inhibited.

Since in the present invention, the requirements described above are satisfied and moreover, the SHE potential is high, silver fluoride (AgF₂) is most preferable.

[Fluoride Ion Conductive Fluoride]

The fluoride ion conductive fluoride which is an essential constituent component of the negative electrode material mixture composite for a fluoride ion secondary battery according to the present invention is not particularly limited as long as the fluoride ion conductive fluoride is a fluoride having fluoride ion conductivity. For example, Ce_{0.95}Ba_{0.05}F_{2.95}, Ba_{0.6}La_{0.4}F_{2.4} and the like are mentioned.

Among them, Ce_{0.95}Ba_{0.08}F_{2.95} is preferably used because it has high ion conductivity.

(Average Particle Diameter)

The average particle diameter of the fluoride ion conductive fluoride is preferably in a range of 0.1 to 100 μm, and is particularly preferably in a range of 0.1 to 10 μm.

The average particle diameter of the fluoride ion conductive fluoride is in the range of 0.1 to 100 μm, and thus it is possible to form an electrode of a thin film having relatively high ion conductivity.

[Other Components]

The negative electrode material mixture composite for a fluoride ion secondary battery according to the present invention may arbitrarily include other components other than aluminum and the metal fluoride serving as the negative electrode active material and the fluoride ion conductive fluoride which are essential constituent components. Examples of the other components include a conductive aid, a binder and the like.

(Conductive Aid)

In particular, the negative electrode material mixture composite for a fluoride ion secondary battery according to the present invention preferably includes carbon black as the conductive aid. The carbon black is present within the composite, and thus the electron conduction path and the ion conduction path for fluorination/defluorination reactions necessary for the electrochemical reaction can be easily formed.

The type of carbon black is not particularly limited, and examples thereof include furnace black, Ketjen black, acetylene black and the like.

Although the average particle diameter of the carbon black is not particularly limited, the average particle diameter is preferably in a range of 20 to 50 nm.

The average particle diameter of the carbon black is in the range of 20 to 50 nm, and thus an electrode having high electron conductivity with a small weight can be formed.

[Composition]

### (Aluminum)

The ratio of aluminum to the entire negative electrode material mixture composite for a fluoride ion secondary battery according to the present invention is preferably 1 to 25% by mass, and is further preferably in a range of 1 to 13% by mass.

In the negative electrode material mixture composite for a fluoride ion secondary battery according to the present invention, the ratio of aluminum is in the range described above, and thus the capacity of the obtained fluoride ion secondary battery per weight is increased.

(Metal Fluoride)

The ratio of the metal fluoride to the entire negative electrode material mixture composite for a fluoride ion secondary battery according to the present invention is preferably 0.4 to 25% by mass, and is further preferably in a range of 0.4 to 13% by mass.

In the negative electrode material mixture composite for a fluoride ion secondary battery according to the present invention, the ratio of the metal fluoride is in the range described above, and thus the capacity of the obtained fluoride ion secondary battery per weight is increased.

(Ratio Between Aluminum and Metal Fluoride)

In the negative electrode material mixture composite for a fluoride ion secondary battery according to the present invention, a mass ratio between aluminum and the metal fluoride serving as the negative electrode active material is preferably in a range of 7:3 to 4:6. The mass ratio is further preferably in a range of 7:3 to 5:5.

(Fluoride Ion Conductive Fluoride)

The ratio of the fluoride ion conductive fluoride to the entire negative electrode material mixture composite for a fluoride ion secondary battery according to the present invention is preferably 70 to 90% by mass, and is further preferably in a range of 80 to 90% by mass.

In the negative electrode material mixture composite for a fluoride ion secondary battery according to the present invention, the ratio of the fluoride ion conductive fluoride is in the range described above, and thus an electrode having high ion conductivity can be formed.

(Conductive Aid)

When the negative electrode material mixture composite for a fluoride ion secondary battery according to the present invention includes the conductive aid, the ratio of the conductive aid to the entire negative electrode material mixture composite for a fluoride ion secondary battery is preferably 5 to 25V by mass, and is further preferably in a range of 5 to 10% by mass.

In the negative electrode material mixture composite for a fluoride ion secondary battery according to the present invention, the ratio of the conductive aid is in the range described above, and thus an electrode having high electron conductivity can be formed.

(Ratio Between Aluminum, Metal Fluoride, Fluoride Ion Conductive Fluoride and Conductive Aid)

In the negative electrode material mixture composite for a fluoride ion secondary battery according to the present invention, a mass ratio between aluminum, the metal fluoride, the fluoride ion conductive fluoride and the conductive aid is preferably in a range of 1 to 25:0.4 to 25:70 to 90:5 to 25. The mass ratio is further preferably in a range of 1 to 13:0.4 to 13:80 to 90:5 to 10.

In the negative electrode material mixture composite for a fluoride ion secondary battery according to the present invention, the mass ratio between aluminum, the metal fluoride, the fluoride ion conductive fluoride and the conductive aid is in the range described above, and thus the capacity of the obtained fluoride ion secondary battery per weight is increased.

### <Negative Electrode for Fluoride Ion Secondary Battery>

A negative electrode for a fluoride ion secondary battery according to the present invention includes the negative electrode material mixture composite for a fluoride ion secondary battery according to the present invention. As long as the negative electrode includes the negative electrode material mixture composite for a fluoride ion secondary battery according to the present invention, the other configurations are not particularly limited.

### <Fluoride Ion Secondary Battery>

A fluoride ion secondary battery according to the present invention includes: the negative electrode for a fluoride ion secondary battery which includes the negative electrode material mixture composite for a fluoride ion secondary battery according to the present invention; a solid electrolyte; and a positive electrode. As long as the fluoride ion secondary battery according to the present invention uses the negative electrode including the negative electrode material mixture composite for a fluoride ion secondary battery according to the present invention, the other configurations are not particularly limited.

In the present invention, a positive electrode material is selected which provides a sufficiently high standard electrode potential to the standard electrode potential of the negative electrode for a fluoride ion secondary battery including the negative electrode material mixture composite for a fluoride ion secondary battery according to the present invention, and thus it is possible to realize the enhanced characteristics of the fluoride ion secondary battery and a desired battery voltage.

In particular, as the positive electrode, a material which does not include fluoride ions is selected, and thus a battery which starts from charge can be realized. In other words, it is possible to manufacture the battery in a discharged state where an energy state is low, and thus the stability of the active material within the electrode can be enhanced.

Examples of the positive electrode which is preferable for the fluoride ion secondary battery according to the present invention include Cu, Bi, Ag and the like, and among them, Cu is particularly preferable because it is an inexpensive material.

### <Method for Manufacturing Negative Electrode Material Mixture Composite for Fluoride Ion Secondary Battery>

A method for manufacturing the negative electrode material mixture composite for a fluoride ion secondary battery according to the present invention includes a mixture step and a complexing step.

[Mixture Step]

The mixture step in the method for manufacturing the negative electrode material mixture composite for a fluoride ion secondary battery according to the present invention is a step of mixing the negative electrode active material, the fluoride ion conductive fluoride and the carbon black to obtain a negative electrode material mixture, and in the present invention, the negative electrode active material includes aluminum and the metal fluoride.

Aluminum and the metal fluoride serving as the negative electrode active material, the fluoride ion conductive fluoride and the carbon black serving as the conductive aid are the same as those described above. Aluminum, the metal fluoride, the fluoride ion conductive fluoride and the carbon black are preferably included as essential components, and other materials may be arbitrarily mixed.

A method for the mixing is not particularly limited, and it is preferable to weigh the desired masses of the individual components and to put them into the same space simultaneously or sequentially so as to mix them. When they are sequentially put, the order thereof is not particularly limited.

[Complexing Step]

The complexing step is a step of subjecting the negative electrode material mixture obtained in the mixture step to grinding and mixing treatment to complex the negative electrode active material, the fluoride ion conductive fluoride and the carbon black so as to obtain the composite.

In the complexing step, the negative electrode active material, the fluoride ion conductive fluoride and the carbon black included in the negative electrode material mixture are alloyed.

Since aluminum serving as the negative electrode active material is a relatively soft material, aluminum is carried by the fluoride ion conductive fluoride which is a hard material due to an impact caused by the grinding and mixing treatment. Then, it is considered that since aluminum is nanoparticles, aluminum can be thermally diffused within the composite due to heat caused by the grinding and mixing treatment, and that consequently, the composite is alloyed.

The grinding and mixing treatment for alloying and granulating the negative electrode material mixture is not particularly limited as long as the grinding and mixing treatment is a method in which the negative electrode material mixture can be mixed while being ground under an inert atmosphere.

Although the grinding and mixing treatment may be dry grinding or wet grinding, since an oxide film on the surface of the particles peels off at the time of the grinding and mixing treatment to cause an active surface to appear, the dry grinding under an inert atmosphere is preferable.

In the present invention, in particular, the grinding and mixing treatment is preferably performed with a ball mill. Since the ball mill is sealed, the mixing ratio is not changed during grinding and dispersion, the stable grinding and mixing treatment can be performed. Among types of ball mills, a planetary ball mill is preferable because large griding power is produced to be able to perform fine grinding and reduce the grinding time. Although the conditions of the grinding and mixing when the ball mill is used are not particularly limited, for example, the grinding and mixing is performed at 400 rpm for 10 hours.

### EXAMPLES

Although Example and the like in the present invention will then be described, the present invention is not limited to Example and the like described below.

### Example 1

In Example 1, aluminum and silver fluoride (AgF₂) serving as a negative electrode active material, CeBaF_{2.95} serving as a fluoride ion conductive fluoride and acetylene black serving as a conductive aid were used to produce a negative electrode material mixture composite for a fluoride ion secondary battery.

[Mixture Step]

Aluminum, the silver fluoride (AgF₂), Ce_{0.95}Ba_{0.95}F_{2.95} and the acetylene black were weighed as shown in table 1. After the weighing, Ce_{0.95}Ba_{0.95}F_{2.95} and the acetylene black were put into a ball mill container made of silicon nitride (made by Fritsch Co., Ltd. in Germany, internal volume: 80 cc, PL-7 dedicated container), and then aluminum and the silver fluoride (AgF₂) were put thereinto. Furthermore, 40 g of balls having a diameter of 2 mm and made of silicon nitride was put thereinto, and the ball mill container was sealed.

[Complexing Step]

The sealed ball mill container was rotated at a rotation speed of 400 rpm for 10 hours to perform grinding and mixing treatment, and thus the negative electrode material mixture composite for a fluoride ion secondary battery was obtained. After the grinding and mixing treatment, the processed powder was collected. A collection rate is shown in table 1.

TABLE 1

| | | | Comparative | Comparative |
|---|---|---|---|---|
| | | Example 1 | Example 1 | Example 2 |
| Negative electrode | Type | Aluminum | Modified aluminum | Aluminum |
| active material (1) | | | fluoride | |
| | Average particle | 40 | 49 | 40 |
| | diameter (nm) | | | |
| | Mixed amount (mg) | 156 | 250 | 200 |
| Negative electrode | Type | Silver fluoride | — | — |
| active material (2) | | (AgF₂) | | |
| | Mixed amount (mg) | 94 | — | — |
| Fluoride ion | Type | CeBaF_{2.95} | CeBaF_{2.95} | CeBaF_{2.95} |
| conductive fluoride | Average particle | 10 | 10 | 10 |
| | diameter (nm) | | | |
| | Mixed amount (mg) | 1633 | 1633 | 1584 |
| Conductive aid | Type | Acetylene black | Acetylene black | Acetylene black |
| | Average particle | 35 | 35 | 35 |
| | diameter (nm) | | | |
| | Mixed amount (mg) | 117 | 117 | 216 |

| | | | |
|---|---|---|---|
| Collection rate (mass %) | 90.0 | 94.0 | 78.0 |

### Comparative Example 1

A negative electrode material mixture for a fluoride ion secondary battery was obtained as in Example 1 except that instead of aluminum and the silver fluoride (AgF₂), modified aluminum fluoride disclosed in Japanese Unexamined Patent Application, Publication No. 2018-059703 was used as the negative electrode active material.

An operation for obtaining the modified aluminum fluoride is described below. The collection rate of the negative electrode material mixture for a fluoride ion secondary battery which was obtained is shown in table 1.

[Modified Aluminum Fluoride]

Lithium (Li) metal was used, and thus aluminum fluoride (AlF₃) was formed into the modified aluminum fluoride.

(Weighing and Preliminary Mixing of Raw Materials)

The aluminum fluoride (AlF₃) and the lithium (Li) metal were weighed such that aluminum fluoride:lithium (mole rate) was 90:10 and that the total amount was 6.0 grams. A mortar and a pestle made of agate were used to perform preliminary mixing for about 1 hour, and thus the mixed powder of raw materials was obtained.

Since each of the aluminum fluoride (AlF₃) and the lithium (Li) metal was highly reactive with water, the weighing and the preliminary mixing of the raw materials were performed within a glove box (made by Miwa Manufacturing Co., Ltd., model DBO-1.5BNK-SQ1).

### Comparative Example 2

A negative electrode material mixture composite for a fluoride ion secondary battery was obtained as in Example 1 except that only aluminum was used as the negative electrode active material without use of the silver fluoride (AgF₂).

### <Evaluations of Negative Electrode Material Mixture Composite for Fluoride Ion Secondary Battery>

Various types of observations and evaluations were performed on the negative electrode material mixture composites for a fluoride ion secondary battery and the negative electrode material mixture for a fluoride ion secondary battery produced in Example and Comparative Examples.

[X-Ray Diffraction Pattern]

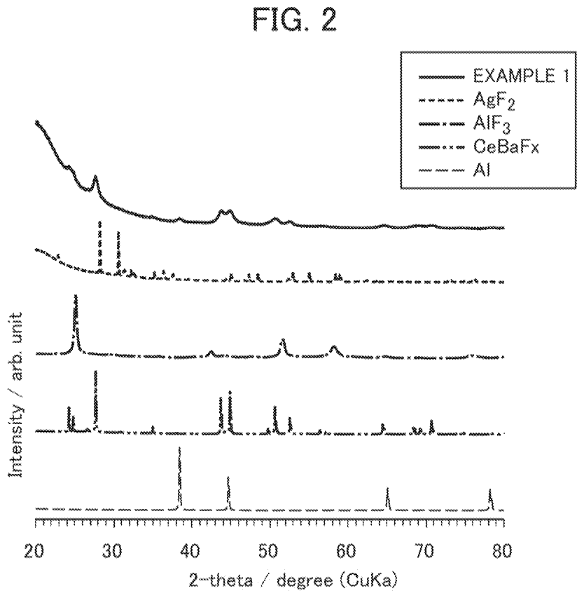

An XRD (made by Rigaku Corporation, SmartLaB, Cu-Kα source, λ=1.5418 Å) was used to analyze the crystal structures of the negative electrode material mixture composite for a fluoride ion secondary battery produced in Example 1, aluminum (Al), the silver fluoride (AgF₂), CeBaF_{2.95} (represented by CeBaFₓ) and the modified aluminum fluoride (AlF₃) obtained in Comparative Example 1. An XRD chart is shown in FIG. 2.

As shown in FIG. 2, in the negative electrode material mixture composite for a fluoride ion secondary battery produced in Example 1, a single peak of aluminum (Al) was not confirmed. Hence, it is found that in the negative electrode material mixture composite for a fluoride ion secondary battery produced in Example 1, aluminum is present in an alloyed state.

### <Production of Fluoride Ion Secondary Battery>

A fluoride ion secondary battery was produced using materials below by the following method.

[Negative Electrode Material Mixture Powder]

The negative electrode material mixture composite for a fluoride ion secondary battery or the negative electrode material mixture for a fluoride ion secondary battery produced in Example and Comparative Examples was used.

[Solid Electrolyte]

La_{0.95}Ba_{0.95}F_{2.95} (LBF) which was a tysonite-based solid electrolyte was used. The LBF was a known compound (see Non-Patent Documents 5 to 7), and thus the LBF was produced by a method disclosed in Non-Patent Document 5. Non-Patent Document 5: ACS Appl. Mater. Tnterfaces 2014, 6, 2103-2110
Non-Patent Document 6: J. Phys. Chem. C 2013,117, 4943-4950
Non-Patent Document 7: J. Phys. Chem. C 2014,118, 7117-7129

[Positive Electrode Material Mixture Powder]

63.7% by mass of lead fluoride powder (made by Kojundo Chemical Lab. Co., Ltd.), 29.6% by mass of tin fluoride (made by Kojundo Chemical Lab. Co., Ltd.) and 6.7% by mass of acetylene black (made by Denka Company Limited) were mixed with a ball mill, and were thereafter burned at 400° C. for 1 hour under an argon atmosphere to form into positive electrode material mixture powder.

[Method for Producing Fluoride Ion Secondary Battery]

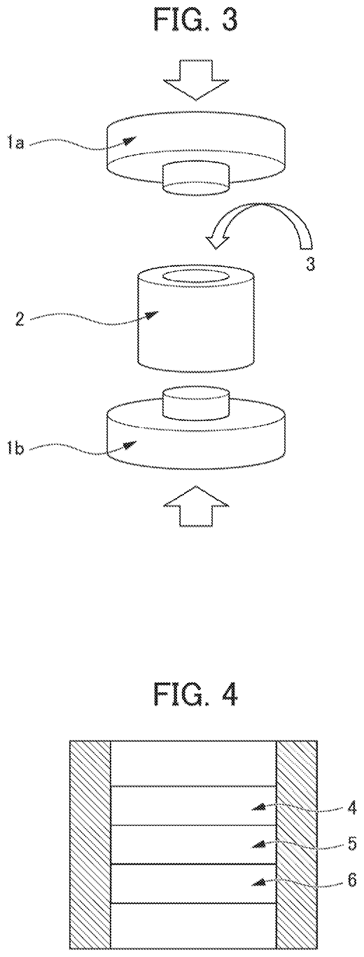

FIG. 3 shows a method for producing the fluoride ion secondary battery. As shown in FIG. 3, a tablet molder (1a and 1b) was used, battery materials 3 were sequentially put into a ceramic pipe 2 to be pressed at a pressure of 40 MPa from above and below and thus a pellet-type cell obtained by powder pressure molding was produced. As the battery materials 3, gold foil (made by the Nilaco Corporation, 99.9+%, thickness: 10 μm) serving as a negative electrode current collector, 10 mg of the negative electrode material mixture powder described above, 200 mg of the solid electrolyte, 30 mg of the positive electrode material mixture powder and lead foil (made by the Nilaco Corporation, purity: 99.99%, thickness: 200 μm) serving as a positive electrode current collector were sequentially put.

FIG. 4 shows a cross-sectional view of the fluoride ion secondary battery which was produced. As shown in FIG. 4, in a state where the pellet-type fluoride ion secondary battery produced was sandwiched by the tablet molder, a positive electrode material mixture layer 4, a solid electrolyte layer 5 and a negative electrode material mixture layer 6 were stacked.

### <Evaluations of Fluoride Ion Secondary Battery>

### [Constant Current Charge/Discharge Test]

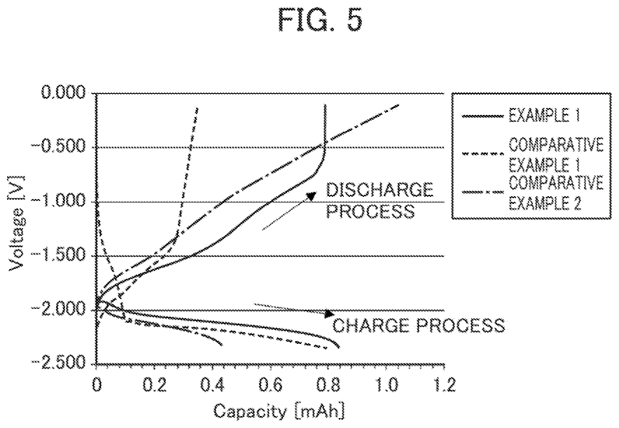

The pellet-type fluoride ion secondary battery obtained as described above was heated to 140° C. under a vacuum environment, and thus an electrochemical reaction (charge/discharge reaction) was performed. Specifically, a potentiometer galvanostat device (made by Solartron, SI1287/1255B) was used to perform a constant current charge/discharge test with a current of 0.02 mA for charge and a current of 0.01 mA for discharge at a lower limit voltage of −2.35 V and an upper limit voltage of −0.1 V on the fluoride ion secondary batteries produced in Example 1 and Comparative Example 1 by application of the current from a charge current and on the fluoride ion secondary battery produced in Comparative Example 2 by application of the current from a discharge current. Charge/discharge curves are shown in FIG. 5.

It is found from FIG. 5 that in the fluoride ion secondary battery using the negative electrode material mixture composite for a fluoride ion secondary battery according to the present invention, even when charge and discharge is performed by starting from charge, a difference between the capacity at the time of charge and the capacity at the time of discharge is low and the reversibility of the electrochemical reaction is improved.

### EXPLANATION OF REFERENCE NUMERALS

1a, 1b: tablet molder
2: ceramic pipe
3: battery material
4: positive electrode material mixture layer
5: solid electrolyte layer
6: negative electrode material mixture layer

1. A negative electrode material mixture composite for a fluoride ion secondary battery comprising: a negative electrode active material; and a fluoride ion conductive fluoride,
wherein the negative electrode active material comprises aluminum and a metal fluoride.

2. The negative electrode material mixture composite for a fluoride ion secondary battery according to claim 1, wherein the metal fluoride discharges fluoride ions under a battery reaction condition and comprises a metal with an SHE potential equal to or greater than 0 V.

3. The negative electrode material mixture composite for a fluoride ion secondary battery according to claim 1, wherein the metal fluoride is silver fluoride.

4. The negative electrode material mixture composite for a fluoride ion secondary battery according to claim 1, wherein the aluminum is in the form of particles with an average particle diameter of 10 to 200 nm.

5. The negative electrode material mixture composite for a fluoride ion secondary battery according to claim 1, further comprising carbon black.

6. A negative electrode for a fluoride ion secondary battery comprising the negative electrode material mixture composite for a fluoride ion secondary battery according to claim 1.

7. A fluoride ion secondary battery comprising: the negative electrode according to claim 6; a solid electrolyte; and a positive electrode.

8. A method for manufacturing a negative electrode material mixture composite for a fluoride ion secondary battery, the method comprising:
a mixture step of mixing a negative electrode active material, a fluoride ion conductive fluoride and carbon black to obtain a negative electrode material mixture; and
a complexing step of subjecting the negative electrode material mixture to grinding and mixing treatment to complex the negative electrode active material, the fluoride ion conductive fluoride and the carbon black so as to obtain a composite,
wherein the negative electrode active material comprises aluminum and a metal fluoride.

9. The method for manufacturing a negative electrode material mixture composite for a fluoride ion secondary battery according to claim 8, wherein the metal fluoride discharges fluoride ions under a battery reaction condition and comprises a metal with an SHE potential equal to or greater than 0 V.

10. The method for manufacturing a negative electrode material mixture composite for a fluoride ion secondary battery according to claim 8, wherein the metal fluoride is silver fluoride.

11. The method for manufacturing a negative electrode material mixture composite for a fluoride ion secondary battery according to claim 8, wherein the aluminum is in the form of particles with an average particle diameter of 10 to 200 nm.

12. The method for manufacturing a negative electrode material mixture composite for a fluoride ion secondary battery according to claim 8, wherein the grinding and mixing treatment is dry grinding.

13. The method for manufacturing a negative electrode material mixture composite for a fluoride ion secondary battery according to claim 8, wherein the grinding and mixing treatment is performed with a ball mill.
